(19) United States
(12) Patent Application Publication
(10) Pub. No.: US 2026/0148738 A1
(43) Pub. Date: May 28, 2026

(54) ELECTRONIC DEVICE, AND METHOD FOR PROCESSING UTTERANCE OF USER BY USING LOCATION-BASED CONTEXT IN ELECTRONIC DEVICE

(71) Applicant: Samsung Electronics Co., Ltd., Suwon-si (KR)

(72) Inventor: Jinwook KIM, Suwon-si (KR)

(21) Appl. No.: 19/178,104

(22) Filed: Apr. 14, 2025

Related U.S. Application Data
(63) Continuation of application No. PCT/KR2023/015600, filed on Oct. 11, 2023.

(30) Foreign Application Priority Data
Oct. 14, 2022 (KR) 10-2022-0131977
Nov. 7, 2022 (KR) 10-2022-0146910

(51) Int. Cl. G10L 15/22; G06F 16/22

(52) U.S. Cl. CPC G10L 15/22; G06F 16/22; G10L 2015/223; G10L 2015/228

(57) ABSTRACT

An electronic device is provided. The electronic device includes an input module, memory storing one or more computer programs, and at least one processor communicatively coupled to the input module and the memory, wherein the one or more computer programs include computer-executable instructions that, when executed by the at least one processor individually or collectively, cause the electronic device to identify a user utterance obtained through the input module as a shortcut command including a plurality of commands, when identifying a command for which a location-based context condition is set among the plurality of commands while sequentially executing the plurality of commands included in the shortcut command, identify whether the location-based context condition is satisfied based on location information about the electronic device and location information about a target for which the command is to be executed, and perform a task corresponding to the command, when the location-based context condition is satisfied.

### CROSS-REFERENCE TO RELATED APPLICATION(S)

This application is a continuation application, claiming priority under 35 U.S.C. § 365(c), of an International application No. PCT/KR2023/015600, filed on October 11, 2023, which is based on and claims the benefit of a Korean patent application number 10-2022-0131977, filed on October 14, 2022, in the Korean Intellectual Property Office, and of a Korean patent application number 10-2022-0146910, filed on November 7, 2022, in the Korean Intellectual Property Office, the disclosure of each of which is incorporated by reference herein in its entirety.

### BACKGROUND

### 1. Field

The disclosure relates to an electronic device and a method of processing a user utterance in the electronic device.

### 2. Description of Related Art

Portable digital communication devices have become an essential element for many people living in the modern era. Consumers want to receive various high-quality services they want anytime and anywhere using portable digital communication devices.

A voice recognition service is a service that provides various content services to consumers in response to a received user's voice, based on a voice recognition interface implemented in portable digital communication devices. In order to provide the voice recognition service, portable digital communication devices implement technologies of recognizing and analyzing human languages (e.g., automatic speech recognition, natural language understanding, natural language generation, machine translation, conversational system, question and response, and speech recognition/synthesis).

A user command transmitted by the voice recognition service is provided in various ways, such as a user utterance or text.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method of processing a user utterance in the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes an input module, memory storing one or more computer programs, and at least one processor communicatively coupled to the input module and the memory, wherein the one or more computer programs include computer-executable instructions that, when executed by the at least one processor individually or collectively, cause the electronic device to identify a user utterance obtained through the input module as a shortcut command including a plurality of commands, when identifying a command for which a location-based context condition is set among the plurality of commands while sequentially executing the plurality of commands included in the shortcut command, identify whether the location-based context condition is satisfied based on location information about the electronic device and location information about a target for which the command is to be executed, and perform a task corresponding to the command, when the location-based context condition is satisfied.

In accordance with another aspect of the disclosure a method of processing a user utterance using a location-based context in an electronic device is provided. The method includes identifying a user utterance obtained through an input module of the electronic device as a shortcut command including a plurality of commands, when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed, and performing a task corresponding to the command, when the location-based context condition is satisfied.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a user utterance obtained through an input module of the electronic device as a shortcut command including a plurality of commands, when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed, and performing a task corresponding to the command, when the location-based context condition is satisfied.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an integrated intelligence system according to an embodiment of the disclosure;

FIG. 3 is a diagram illustrating relationship information between concepts and actions stored in a database according to an embodiment of the disclosure;

FIG. 4 is a diagram illustrating a user terminal displaying a screen for processing a voice input received through an intelligent app according to an embodiment of the disclosure;

FIG. 5 is a block diagram illustrating an electronic device according to an embodiment of the disclosure;

FIG. 6 is a diagram illustrating an operation of setting a location-based context condition for a command in an electronic device according to an embodiment of the disclosure;

FIG. 7 is a diagram illustrating an operation of setting a location-based context condition for a command in an electronic device according to an embodiment of the disclosure;

FIG. 8 is a flowchart illustrating an operation of processing a user utterance using a location-based context in an electronic device according to an embodiment of the disclosure;

FIG. 9 is a flowchart illustrating an operation of processing a user utterance using a location-based context in an electronic device according to an embodiment of the disclosure;

FIG. 10 is a flowchart illustrating an operation of processing a user utterance using a location-based context in an electronic device according to an embodiment of the disclosure; and

FIG. 11 is a flowchart illustrating an operation of processing a user utterance using a location-based context in an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

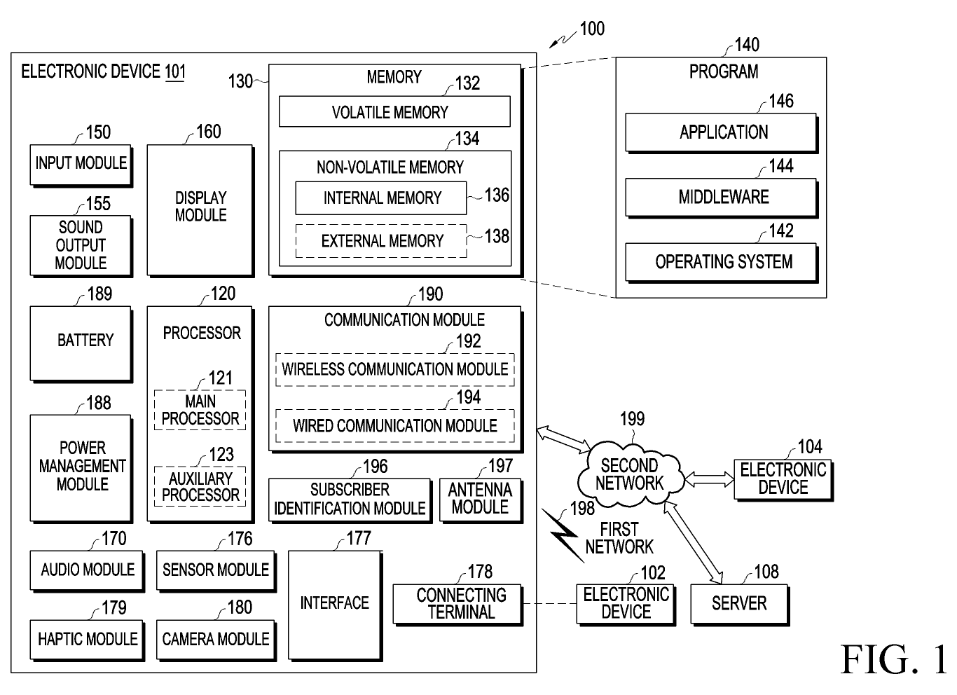

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, (e.g., by the electronic device 101 where the artificial intelligence is performed or via a separate server (e.g., the server 108). Learning algorithms may include, but are not limited to, (e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the strength of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, (e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, (e.g., a high data transmission rate. The wireless communication module 192 may support various technologies for securing performance on a high-frequency band, such as, (e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to an embodiment of the disclosure, the antenna module 197 may form an mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, (e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

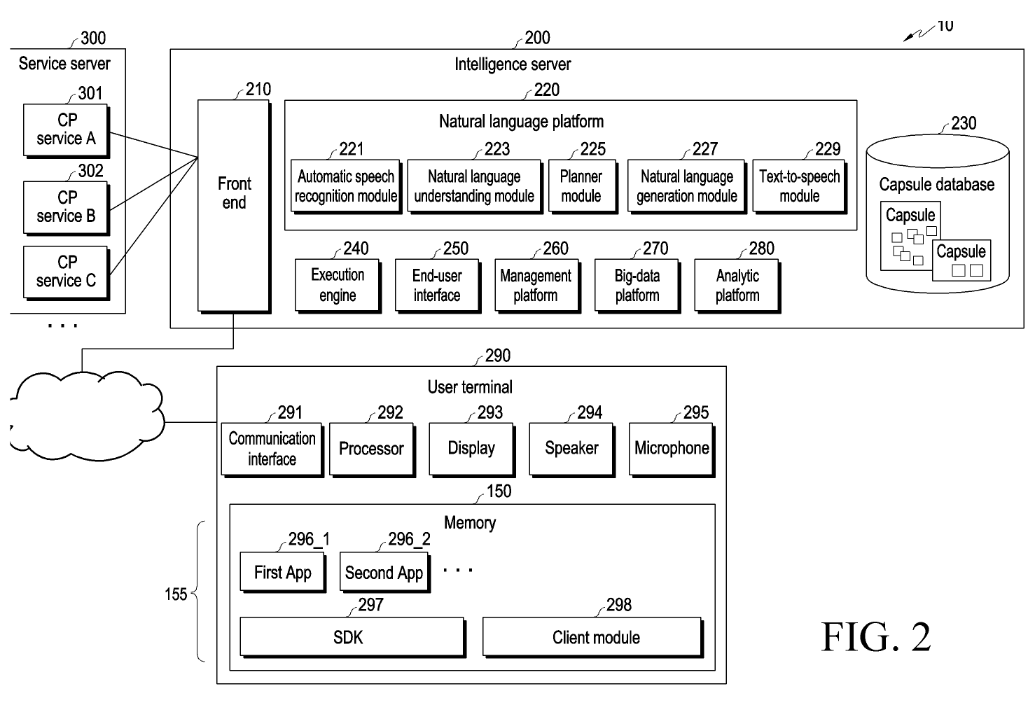

FIG. 2 is a block diagram illustrating an integrated intelligence system according to an embodiment of the disclosure.

Referring to FIG. 2, an integrated intelligence system 10 of an embodiment may include a user terminal 290, an intelligent server 200, and a service server 300.

The user terminal 290 of an embodiment may be a terminal device (or electronic device) that may connect to the Internet, and may be, for example, a mobile phone, a smart phone, a personal digital assistant (PDA), a notebook computer, a TV, white goods, an electronic device, an HMD, or a smart speaker.

According to the illustrated embodiment of the disclosure, the user terminal 290 (e.g., the electronic device 101 of FIG. 1) may include a communication interface 291, a microphone 295, a speaker 294, a display 293, memory 299, or a processor 292. The above components may be operatively or electrically connected to each other.

The communication interface 291 of an embodiment may be connected to an external device and configured to transmit and receive data to and from the external device. The microphone 295 of an embodiment may receive sound (e.g., a user utterance) and convert it into an electrical signal. The speaker 294 of an embodiment may output an electrical signal as sound (e.g., voice). The display 293 of an embodiment may be configured to display an image or video. The display 293 of an embodiment may also display a graphic user interface (GUI) of a running app (or application program).

The display 293 of an embodiment may be configured to display an image or video. The display 293 of an embodiment may also display a GUI of a running app (or application program). The display 293 of an embodiment may receive a touch input through a touch sensor. For example, the display 293 may receive a text input through a touch sensor in an on-screen keyboard area displayed within the display 293.

The memory 299 of an embodiment may store a client module 298, a software development kit (SDK) 297, and a plurality of apps 296. The client module 298 and the SDK 297 may configure a framework (or solution program) for performing general-purpose functions. Further, the client module 298 or the SDK 297 may configure a framework for processing a user input (e.g., voice input, text input, or touch input).

The plurality of apps 296 in the memory 299 of an embodiment may be programs for performing specified functions. According to an embodiment of the disclosure, the plurality of apps 296 may include a first app 296_1 and a second app 296_2. According to an embodiment of the disclosure, each of the plurality of apps 296 may include a plurality of operations for performing a specified function. For example, the apps may include an alarm app, a message app, and/or a schedule app. According to an embodiment of the disclosure, the plurality of apps 296 may be executed by the processor 292 and sequentially perform at least some of the plurality of operations.

The processor 292 of an embodiment may control the overall operation of the user terminal 290. For example, the processor 292 may be electrically connected to the communication interface 291, the microphone 295, the speaker 294, and the display 293 and perform a specified operation.

The processor 292 of an embodiment may also perform a specified function by executing a program stored in the memory 299. For example, the processor 292 may perform the following operations for processing a user input by executing at least one of the client module 298 or the SDK 297. The processor 292 may control the operations of the plurality of apps 296 through, for example, the SDK 297. The following operations described as operations of the client module 298 or the SDK 297 may be operations executed by the processor 292.

The client module 298 of an embodiment may receive a user input. For example, the client module 298 may generate a voice signal corresponding to a user utterance detected through the microphone 295. Alternatively, the client module 151 may receive a touch input detected through the display module 160. Alternatively, the client module 151 may receive a text input detected through a keyboard or an on-screen keyboard. In addition, the client module 151 may receive various types of user inputs detected through an input module included in the user terminal 290 or an input module connected to the user terminal 290. The client module 298 may transmit the received user input to the intelligent server 200. The client module 298 may transmit status information about the user terminal 290 together with the received user input to the intelligent server 200. The status information may be, for example, execution status information about an app.

The client module 298 of an embodiment may receive a result corresponding to the received user input. For example, the client module 298 may receive the result corresponding to the user input from the intelligent server 200. The client module 298 may display the received result on the display 293. Further, the client module 298 may output the received result as audio through the speaker 294.

The client module 298 of an embodiment may receive a plan corresponding to the received user input. The client module 298 may display results of executing a plurality of operations of an app according to the plan on the display 293. For example, the client module 298 may sequentially display the execution results of the plurality of operations on the display 293 and output audio through the speaker 294. In another example, the user terminal 290 may display only some (e.g., the result of a last operation) of the execution results of the plurality of operations on the display 293 and output audio through the speaker 294.

According to an embodiment of the disclosure, the client module 298 may receive a request from the intelligent server 200 to obtain information required for producing a result corresponding to the user input. The information required for producing the result may be, for example, status information about the user terminal 290. According to an embodiment of the disclosure, the client module 298 may transmit the required information to the intelligent server 200 in response to the request.

The client module 298 of an embodiment of the disclosure may transmit result information of executing the plurality of operations according to the plan to the intelligent server 200. The intelligent server 200 may identify that the received user input has been correctly processed, using the result information.

The client module 298 of an embodiment of the disclosure may include a voice recognition module. According to an embodiment of the disclosure, the client module 298 may recognize a voice input by which a limited function is executed through the voice recognition module. For example, the client module 298 may execute an intelligent app for processing a voice input to perform an organic operation through a specified input (e.g., wake up!).

The intelligent server 200 of an embodiment of the disclosure may receive information related to a user voice input from the user terminal 290 through a communication network. According to an embodiment of the disclosure, the intelligent server 200 may change data related to the received voice input into text data. According to an embodiment of the disclosure, the intelligent server 200 may generate a plan for performing a task corresponding to the user voice input, based on the text data.

According to an embodiment of the disclosure, the plan may be generated by an artificial intelligence (AI) system. The AI system may be a rule-based system, a neural network-based system (e.g., a feedforward neural network (FNN)), or a recurrent neural network (RNN). Alternatively, the AI system may be a combination of the above systems or another AI system. According to an embodiment of the disclosure, the plan may be selected from a set of predefined plans or generated in real time in response to a user request. For example, the AI system may select at least one of a plurality of predefined plans.

The intelligent server 200 of an embodiment of the disclosure may transmit a result of the generated plan to the user terminal 290, or may transmit the generated plan to the user terminal 290. According to an embodiment of the disclosure, the user terminal 290 may display the result of the plan on the display 293. According to an embodiment of the disclosure, the user terminal 290 may display a result of performing an operation according to the plan on the display 293.

The intelligent server 200 of an embodiment of the disclosure may include a front end 210, a natural language platform 220, a capsule database 230, an execution engine 240, an end user interface 250, a management platform 260, a big data platform 270, or an analytic platform 280.

The front end 210 of an embodiment of the disclosure may receive a user input from the user terminal 290. The front end 210 may transmit a response corresponding to the user input.

According to an embodiment of the disclosure, the natural language platform 220 may include an automatic speech recognition (ASR) module 221, a natural language understanding (NLU) module 223, a planner module 225, a natural language generator (NLG) module 227, or a text to speech (TTS) module 229.

The ASR module 221 of an embodiment may convert a voice input received from the user terminal 290 into text data. The NLU module 223 of an embodiment may identify a user's intent using the text data of the voice input. For example, the NLU module 223 may identify the user's intent by performing syntactic analysis or semantic analysis on the user input in the form of the text data. The NLU module 223 of an embodiment may identify the meaning of a word extracted from the user input, using linguistic features (e.g., grammatical elements) of a morpheme or phrase, and determine the user's intent by matching the meaning of the identified word to the intent. The NLU module 223 may obtain intent information corresponding to the user utterance. The intent information may be information indicating the user's intent determined by interpreting the text data. The intent information may include information indicating an action or function that the user intends to execute using the device.

The planner module 225 of an embodiment may generate a plan, using the intent determined by the NLU module 223, and parameters. According to an embodiment of the disclosure, the planner module 225 may determine a plurality of domains required to perform a task based on the determined intent. The planner module 225 may determine a plurality of actions included in each of the plurality of domains determined based on the intent. According to an embodiment of the disclosure, the planner module 225 may determine parameters required to execute the determined plurality of actions, or a result value output by performing the plurality of actions. The parameters and the result value may be defined as a concept of a specified format (or class). Accordingly, the plan may include a plurality of actions and a plurality of concepts determined by the user's intent. The planner module 225 may operatively (or hierarchically) determine a relationship between the plurality of actions and the plurality of concepts. For example, the planner module 225 may determine an execution order of the plurality of actions based on the user's intent based on the plurality of concepts. In other words, the planner module 225 may determine the execution order of the plurality of actions based on parameters required for the execution of the plurality of actions and results output by executing the plurality of actions. Accordingly, the planner module 225 may generate a plan including association information (e.g., ontology) between the plurality of actions and the plurality of concepts. The planner module 225 may generate a plan using information stored in the capsule database 230 in which a set of relationships between concepts and actions are stored.

The NLG module 227 of an embodiment may convert specified information into text. The information converted into the text may be in the form of a natural language speech. The TTS module 229 of an embodiment may change information in the form of text into voice.

According to an embodiment of the disclosure, some or all of the functions of the natural language platform 220 may be implemented in the user terminal 290.

The capsule database 230 of an embodiment may store information about a relationship between a plurality of concepts and actions, which correspond to a plurality of domains. According to an embodiment of the disclosure, a capsule may store a plurality of capsules including a plurality of action objects (or a plurality of pieces of action information) and concept objects (or concept information) included in a plan. According to an embodiment of the disclosure, the capsule database 230 may store the plurality of capsules in the form of a concept action network (CAN). According to an embodiment of the disclosure, the plurality of capsules may be stored in a function registry included in the capsule database 230.

The capsule database 230 of an embodiment of the disclosure may include a strategy registry in which strategy information required for determining a plan corresponding to a voice input is stored. The strategy information may include reference information for determining one plan, when there are a plurality of plans corresponding to a user input. According to an embodiment of the disclosure, the capsule database 230 may include a follow-up registry in which information about a follow-up action for suggesting the follow-up action to the user in a given situation is stored. The follow-up action may include, for example, a follow-up utterance. According to an embodiment of the disclosure, the capsule database 230 may include a layout registry in which information about a layout of information output through the user terminal 290 is stored. According to an embodiment of the disclosure, the capsule database 230 may include a vocabulary registry in which vocabulary information included in capsule information is stored. According to an embodiment of the disclosure, the capsule database 230 may include a dialog registry in which information about a dialogue (or interaction) with the user is stored.

The capsule database 230 of an embodiment may update stored objects through a developer tool. The developer tool may include, for example, a function editor for updating an action object or a concept object. The developer tool may include a vocabulary editor for updating a vocabulary. The developer tool may include a strategy editor for creating and registering a strategy that determines a plan. The developer tool may include a dialog editor for creating a dialogue with the user. The developer tool may include a follow-up editor for activating a follow-up goal and editing a follow-up utterance that provides a hint. The follow-up goal may be determined based on a current set goal, a user preference, or an environmental condition.

In an embodiment of the disclosure, the capsule database 230 may also be implemented in the user terminal 290. In other words, the user terminal 290 may include the capsule database 230 that stores information for determining an action corresponding to a voice input.

The execution engine 240 of an embodiment may calculate a result, using the generated plan. According to an embodiment of the disclosure, the end user interface 250 may transmit the calculated result to the user terminal 290. Accordingly, the user terminal 290 may receive the result and provide the received result to the user. The management platform 260 of an embodiment of the disclosure may manage information used in the intelligent server 200. The big data platform 270 of an embodiment may collect user data. The analytic platform 280 of an embodiment may manage the quality of service (QoS) of the intelligent server 200. For example, the analytic platform 280 may manage the components and processing speed (or efficiency) of the intelligent server 200.

The service server 300 of an embodiment may provide a specific service (e.g., food ordering or hotel reservation) to the user terminal 290. According to an embodiment of the disclosure, the service server 300 may be a server operated by a third party. The service server 300 of an embodiment may provide information for generating a plan corresponding to a received user input to the intelligent server 200. The provided information may be stored in the capsule database 230. Further, the service server 300 may provide result information based on the plan to the intelligent server 200.

In the integrated intelligence system 10 described above, the user terminal 290 may provide various intelligent services to the user in response to a user input. The user input may include, for example, an input through a physical button, a touch input, or a voice input.

In an embodiment of the disclosure, the user terminal 290 may provide a voice recognition service through an intelligent app (or voice recognition app) stored internally. In this case, for example, the user terminal 290 may recognize a user utterance or a voice input received through the microphone and provide a service corresponding to the recognized voice input to the user.

In an embodiment of the disclosure, the user terminal 290 may provide a service to the user alone or together with the intelligent server 200 and/or the service server 300, based on the received voice input.

In an embodiment of the disclosure, when the user terminal 290 provides a service together with the intelligent server 200 and/or the service server 300, the user terminal 290 may detect a user utterance using the microphone 295 and generate a signal (or voice data) corresponding to the detected user utterance. The user terminal 290 may transmit the voice data to the intelligent server 200 using the communication interface 291.

According to an embodiment of the disclosure, in response to the voice input received from the user terminal 290, the intelligent server 200 may generate a plan for performing a task corresponding to the voice input, or a result of executing an action according to the plan. The plan may include, for example, a plurality of actions for performing the task corresponding to the voice input of the user, and a plurality of concepts related to the plurality of actions. A concept may define a parameter input for execution of a plurality of actions, or a result value output by the execution of the plurality of actions. The plan may include association information between a plurality of actions and a plurality of concepts.

The user terminal 290 of an embodiment of the disclosure may receive the response using the communication interface 291. The user terminal 290 may output a voice signal generated inside the user terminal 290 to the outside using the speaker 294, or may output an image generated inside the user terminal 290 to the outside using the display 293.

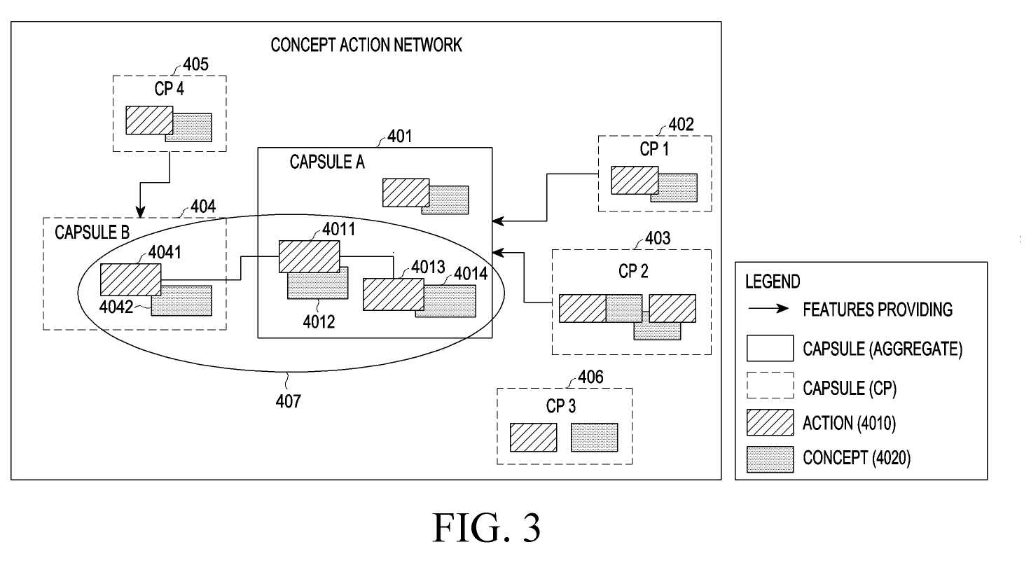

FIG. 3 is a diagram illustrating relationship information between concepts and actions, which is stored in a database according to an embodiment of the disclosure.

Referring FIG. 3, a capsule database (e.g., the capsule database 230 of FIG. 2) of an intelligent server (e.g., the intelligent server 200 of FIG. 2) may store a plurality of capsules in the form of a CAN. The capsule database may store actions for processing a task corresponding to a voice input of the user, and parameters required for the actions, in the form of a CAN. The CAN may represent an organic relationship between actions and concepts that define parameters required to execute the actions.

The capsule database may store a plurality of capsules, capsule A 401 and capsule B 404, corresponding to a plurality of domains (e.g., applications), respectively. According to an embodiment of the disclosure, one capsule (e.g., capsule A 401) may correspond to one domain (e.g., geo or application). Further, one capsule may correspond to at least one service provider (e.g., CP 1402, CP 2403, CP 3406, or CP 4405) for performing a function for a domain related to the capsule. According to an embodiment of the disclosure, one capsule may include at least one action 4010 and at least one concept 4020, for performing a specified function.

According to an embodiment of the disclosure, a natural language platform (e.g., the natural language platform 220 of FIG. 2) may generate a plan for performing a task corresponding to a received voice input, using a capsule stored in the capsule database. For example, a planner module (e.g., the planner module 225 of FIG. 2) of the natural language platform may generate the plan using the capsule stored in the capsule database. For example, a plan 407 may be generated, using actions 4011 and 4013 and concepts 4012 and 4014 of capsule A 401 and an action 4041 and a concept 4042 of capsule B 404.

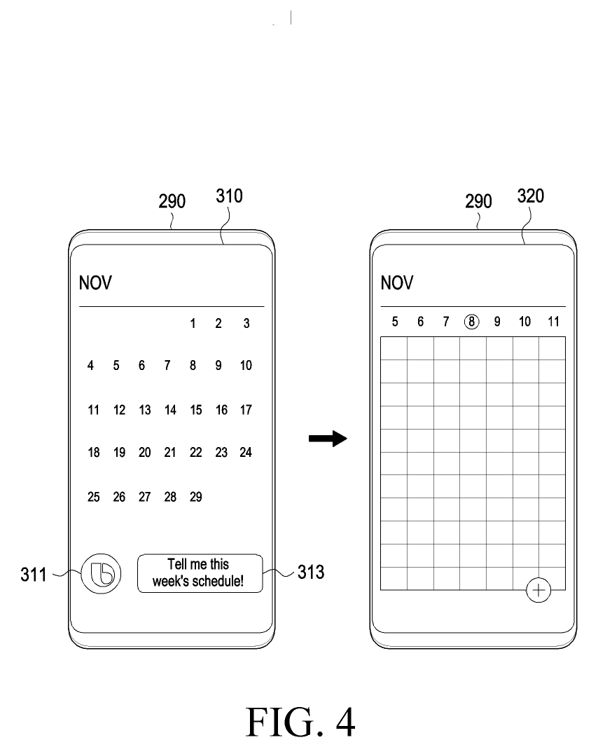

FIG. 4 is a diagram illustrating a screen for processing a voice input received through an intelligent app by a user terminal according to an embodiment of the disclosure.

Referring to FIG. 4, the user terminal 290 may execute the intelligent app to process a user input through an intelligent server (e.g., the intelligent server 200 of FIG. 2).

According to an embodiment of the disclosure, on a screen 310, when the user terminal 290 recognizes a specified voice input (e.g., wake up!) or receives an input through a hardware key (e.g., a dedicated hardware key), the user terminal 290 may execute the intelligent app for processing the voice input. For example, the user terminal 290 may execute the intelligent app while executing a schedule app. According to an embodiment of the disclosure, the user terminal 290 may display an object (e.g., an icon) 311 corresponding to the intelligent app on the display (e.g., the display 293 of FIG. 2). According to an embodiment of the disclosure, the user terminal 290 may receive a voice input by a user utterance. For example, the user terminal 290 may receive a voice input, such as "Tell me this week's schedule!". According to an embodiment of the disclosure, the user terminal 290 may display a user interface (UI) 313 (e.g., an input window) of the intelligent app, on which text data of the received voice input is displayed on the display.

According to an embodiment of the disclosure, on a screen 320, the user terminal 290 may display a result corresponding to the received voice input on the display 293. For example, the user terminal 290 may receive a plan corresponding to the received user input and display 'this week's schedule' on the display 293 according to the plan.

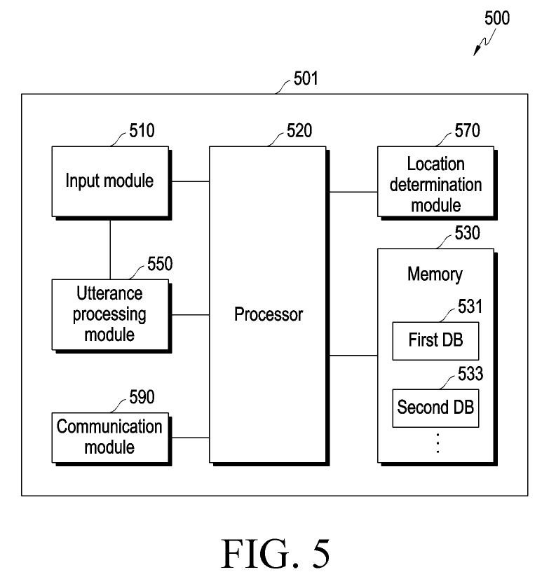

FIG. 5 is a block diagram 500 illustrating an electronic device according to an embodiment of the disclosure.

Referring to FIG. 5, according to an embodiment of the disclosure, an electronic device 501 (e.g., the electronic device 101 of FIG. 1 and/or the user terminal 290 of FIG. 2) may include a processor 520, an input module 510, memory 530, an utterance processing module 550, a location determination module 570, and a communication module 590.

At least some of the components of the electronic device 501 illustrated in FIG. 5 may be identical or similar to components of the electronic device 101 of FIG. 1 and/or the user terminal 290 of FIG. 2, and a redundant description will be avoided below.

Although it is described that a plurality of commands included in a shortcut command are sequentially executed in FIG. 5, by way of example, the plurality of commands included in the shortcut command may be executed in parallel.

According to an embodiment of the disclosure, the processor 520 may be implemented substantially identically or similarly to the processor 120 of FIG. 1 and/or the processor 292 of FIG. 2.

According to an embodiment of the disclosure, when the processor 520 identifies a command for which a location-based context condition is set among a plurality of commands included in a shortcut command while sequentially executing the plurality of commands, the processor may determine whether to perform a task corresponding to the command according to whether the location-based context condition is satisfied. According to an embodiment of the disclosure, the processor 520 may obtain a user utterance through the input module, and when identifying the user utterance as a shortcut command including a plurality of commands through the utterance processing module 550, sequentially execute the plurality of commands included in the shortcut command.

According to an embodiment of the disclosure, when the processor 520 identifies a command for which the location-based context condition is not set while sequentially executing the plurality of commands included in the shortcut command, it may perform a task corresponding to the command.

According to an embodiment of the disclosure, when the processor 520 identifies the command for which the location-based context condition is set while sequentially executing the plurality of commands included in the shortcut command, it may identify whether the location-based context condition is satisfied based on location information of the electronic device and location information about a target (e.g., an external device or a place) for which the command is to be executed, and when the location-based context condition is satisfied, the processor may perform a task corresponding to the command.

According to an embodiment of the disclosure, when the location-based context condition is not satisfied, the processor 520 may not perform the task corresponding to the command.

According to an embodiment of the disclosure, the location-based context condition may include at least one of geofence information or indoor/outdoor information.

According to an embodiment of the disclosure, the location-based context condition may be set by the user through a UI provided by the electronic device, by a developer or manager of a voice service, by an Internet of things (IoT) developer or manager, or by a point of interest (PoI) developer or manager.

According to an embodiment of the disclosure, while sequentially executing the plurality of commands included in the shortcut command, the processor 520 may identify the command for which the location-based context condition is set among the plurality of commands, and when identifying the command for which the location-based context condition is set as a command for controlling an external device, it may determine whether to perform a task for controlling the external device according to whether the location-based context condition is satisfied.

According to an embodiment of the disclosure, when the command for which the location-based context condition is set as a command for controlling the external device, the processor 520 may identify current location information about the electronic device and detect location information about the external device in a first DB 531 storing information about a plurality of external devices among a plurality of DBs included in the memory 530. The processor 520 may detect, for example, latitude and longitude information and/or indoor/outdoor information that may indicate whether the external device exists indoors or outdoors, as the location information about the external device included in the command in the information about the plurality of external devices stored in the first DB 531.

According to an embodiment of the disclosure, the processor 520 may identify the geo-fence information as the location-based context condition set for the command for controlling the external device, and when identifying that the electronic device and the external device exist within a specific area specified by a geo-fence based on the location information (e.g., latitude and longitude information) about the electronic device and the location information (e.g., latitude and longitude information) about the external device, it may determine that the location-based context condition is satisfied and perform a task for controlling the external device.

According to an embodiment of the disclosure, the processor 520 may identify the geo-fence information as the location-based context condition set for the command for controlling the external device, and when identifying that the electronic device and the external device do not exist within the specific area specified by the geo-fence based on the location information (e.g., latitude and longitude information) about the electronic device and the location information (e.g., latitude and longitude information) about the external device, it may determine that the location-based context condition is not satisfied and may not perform the task for controlling the external device.

According to an embodiment of the disclosure, the processor 520 may identify the geo-fence information and the indoor/outdoor information as the location-based context condition set for the command for controlling the external device, and when the electronic device and the external device exist within a specific area specified by the geo-fence based on the location information (e.g., latitude and longitude information) about the electronic device and the location information (e.g., latitude and longitude information) about the external device and the indoor/outdoor information is satisfied, it may determine that the location-based context condition is satisfied and perform the task for controlling the external device.

According to an embodiment of the disclosure, the processor 520 may identify the geo-fence information and the indoor/outdoor information as the location-based context condition set for the command for controlling the external device, and when the electronic device and the external device do not exist within the specific area specified by the geo-fence based on the location information (e.g., latitude and longitude information) about the electronic device and the location information (e.g., latitude and longitude information) about the external device or the indoor/outdoor information is not satisfied, it may determine that the location-based context condition is not satisfied and may not perform the task for controlling the external device.

According to an embodiment of the disclosure, the processor 520 may transmit the location-based context condition, the location information about the electronic device, and the location information about the external device to the location determination module 570, and upon receipt of a result on whether the location-based context condition is satisfied from the location determination module 570, the processor 502 may determine whether to perform the task for controlling the external device, based on the result.

According to an embodiment of the disclosure, the processor 520 may provide a UI for setting the location-based context condition for at least one command for controlling the external device among the plurality of commands included in the shortcut command. The processor 520 may provide the UI for setting the location-based context so that the user may set geofence information and/or indoor/outdoor information for executing the command for controlling the external device.

For example, when the processor 520 analyzes a user utterance and identifies the user utterance as a shortcut command "Go home," it may identify that the shortcut command "Go home" includes a first command "Turn off the office light" and a second command "Give me directions home." When the processor 520 identifies that a location-based context condition is set for the first command, and identifies the location-based context condition set for the first command as a “specific address” which is geofence information and “indoors” which is indoor/outdoor information, the processor 502 may detect current location information (e.g., latitude and longitude information) about the electronic device, and detect location information (e.g., latitude and longitude information and/or indoor/outdoor information) about the light in the first DB 531 of the memory 530. When the processor 520 identifies that the electronic device and the light exist “indoors” at the “specific address” based on the current location information about the electronic device and the location information about the light, the processor 520 may determine that the location-based context condition is satisfied, and turn off the office light to perform a task corresponding to the first command. When the processor 520 identifies that a location-based context condition is not set for the second command, the processor 520 may execute a navigation application to perform a task corresponding to the second command, and start guiding the user home.

According to an embodiment of the disclosure, when identifying a command for which a location-based context condition is set among a plurality of commands included in a shortcut command and identifying the command for which the location-based context condition is set as an incomplete command requiring place information while sequentially executing the plurality of commands, the processor 520 may determine whether to perform a task for controlling the external device based on whether the location-based context condition is satisfied.

According to an embodiment of the disclosure, when the processor 520 identifies the command for which the location-based context condition is set as an incomplete command requiring place information, the processor 520 may identify the current location information about the electronic device and detect a command list including information about a plurality of places generated for the incomplete command in the memory 530. When the processor 520 detects information about a place existing within a specific range based on the current location information about the electronic device among the plurality of places included in the command list, the processor 520 may identify that the location-based context condition is satisfied and perform a task corresponding to the incomplete command based on the detected information about the place.

According to an embodiment of the disclosure, upon detection of information about a plurality of places existing within the specific range in the information about the plurality of places included in the command list based on the location information about the electronic device, using a second DB 533 storing information about a plurality of places among the plurality of DBs of the memory 530, the processor 520 may detect information about a place at the shortest distance from the electronic device in the information about the plurality of places.

According to an embodiment of the disclosure, upon detection of information about a plurality of places at the shortest distance from the location information about the electronic device in the information about the plurality of places included in the command list, using the second DB 533 storing information about the plurality of places among the plurality of DBs of the memory 530, the processor 520 may provide a UI so that the user may select a place from among the plurality of places.

According to an embodiment of the disclosure, when there is no information about a matching place based on the location information about the electronic device in the information about the plurality of places included in the command list, the processor 520 may identify that the location-based context condition is not satisfied, and may not perform the task corresponding to the incomplete command requiring place information.

According to an embodiment of the disclosure, the processor 520 may transmit the command list and the location information about the electronic device to the location determination module 570. Upon receipt of a result satisfying the location-based context condition along with the information about a place at the shortest distance from the location information about the electronic device in the information about the plurality of places included in the command list, it may perform the task corresponding to the incomplete command based on the detected information about the place. When the processor 520 receives, from the location determination module 570, a result indicating that the location-based context condition is not satisfied because there is no information about a place matching the location information about the electronic device in the information about the plurality of places included in the command list, the processor 520 may not perform the task corresponding to the incomplete command requiring place information.

According to an embodiment of the disclosure, the processor 520 may provide a UI on which the location-based context condition may be set for the incomplete command requiring place information among the plurality of commands included in the shortcut command. When the incomplete command requiring place information among the plurality of commands included in the shortcut command is registered through the UI on which the location-based context may be set, the processor 520 may detect information about a plurality of places for which the incomplete command may be executed from the second DB 533 of the memory 530, generate the command list including the information about the plurality of detected places, and provide the command list to the user.

For example, when the processor 520 identifies a user utterance as a shortcut command "Study at a cafe" as a result of analyzing the user utterance, it may identify that the shortcut command "Study at a cafe" includes a first command "Turn on the do not disturb mode" and a second command "Order an Americano." The processor 520 may activate the do not disturb mode in the electronic device as a task corresponding to the first command and then identify the second command. When the processor 520 identifies that the second command "Order an Americano" is an incomplete command requiring place information, it may identify current location information about the electronic device and detect a command list including information about a plurality of places generated for the incomplete command in the memory 530. When the processor 520 identifies that the command list includes Cafe A, Cafe B, and Cafe C, it may detect Cafe A located at the shortest distance from the location of the electronic device among Cafe A, Cafe B, and Cafe C included in the command list, using the second DB 533 storing information about the plurality of places among the plurality of DBs of the memory 530. The processor 520 may determine the second command as "Order an Americano at Cafe A" and order an Americano at Cafe A to perform a task corresponding to the second command.

According to an embodiment of the disclosure, the input module 510 may be implemented substantially identically or similarly to the input module 150 of FIG. 1.

According to an embodiment of the disclosure, the input module 510 may include a microphone.

According to an embodiment of the disclosure, the memory 530 may be implemented substantially identically or similarly to the memory 130 of FIG. 1.

According to an embodiment of the disclosure, the memory 530 may store the plurality of DBs, and the first DB 513 storing information about external devices and the second DB 533 storing place information may be stored among the plurality of DBs.

According to an embodiment of the disclosure, the first DB 531 may store information about a plurality of external devices, and store, for each of the external device, an ID, a name, a type, location information (e.g., latitude and longitude), and indoor/outdoor information indicating whether the external device exists indoors or outdoors. The first DB may store information about a plurality of IoT external devices based on an IoT service, as the information is updated.

According to an embodiment of the disclosure, the second DB 533 may store information about a plurality of places, and store, for each of the plurality of places, an ID, a name, location information (e.g., latitude and longitude), and indoor/outdoor information indicating whether the place exists indoors or outdoors. The second DB may store information about a plurality of places based on a PoI service, as the information is updated.

According to an embodiment of the disclosure, the utterance processing module 550 may analyze and/or interpret a sentence in a user utterance obtained through the input module 150.

According to an embodiment of the disclosure, the location determination module 570 may determine whether a command for which a location-based context condition is set among a plurality of commands included in a shortcut command satisfies the location-based context condition.

According to an embodiment of the disclosure, the location determination module 570 may include a GeoLocation API.

The GeoLocation API, which refers to a JavaScript API used when current location information about a user is retrieved, may perform a location-based service, such as displaying the location of the user on a map or finding a store near the user.

According to an embodiment of the disclosure, when receiving a location-based context condition, location information about the electronic device, and location information about an external device from the processor 520, the location determination module 570 may identify geofence information and/or indoor/outdoor information as a location-based context condition, and when the electronic device and the external device exist within a specific area specified by the geofence based on the location information (e.g., latitude and longitude information) about the electronic device and the location information (e.g., latitude and longitude information) about the external device and satisfy the indoor/outdoor information, transmit a result indicating that the location-based context condition is satisfied to the processor 520. When the electronic device and the external device do not exist within the specific area specified by the geofence based on the location information (e.g., latitude and longitude information) about the electronic device and the location information (e.g., latitude and longitude information) about the external device and do not satisfy the indoor/outdoor information, the location determination module 570 may transmit a result indicating that the location-based context condition is not satisfied to the processor 520.

According to an embodiment of the disclosure, when the location determination module 570 receives a command list and the location information about the electronic device from the processor 520, and detects information about a place at the shortest distance from the location of the electronic device in information about a plurality of places included in the command list, using the second DB 533 storing information about the plurality of places among the plurality of DBs of the memory 530, the location determination module 570 may transmit a result indicating that a the location-based context condition is satisfied together with the information about the place to the processor 520. When there is no information about a place matching the location information about the electronic device in the information about the plurality of places included in the command list, the location determination module 570 may transmit a result indicating that the location-based context condition is not satisfied to the processor 520.

According to an embodiment of the disclosure, the communication module 590 may be implemented substantially identically or similarly to the communication module 190 of FIG. 1, and may include a plurality of communication circuits using different communication technologies.

According to an embodiment of the disclosure, the communication module 590 may include at least one of a wireless LAN module (not shown) or a short-range communication module (not shown), and the short-range communication module (not shown) may include an ultra wide band (UWB) communication module, a wireless fidelity (Wi-Fi) communication module, a near field communication (NFC) communication module, a Bluetooth legacy communication module, and/or a Bluetooth low energy (BLE) communication module.

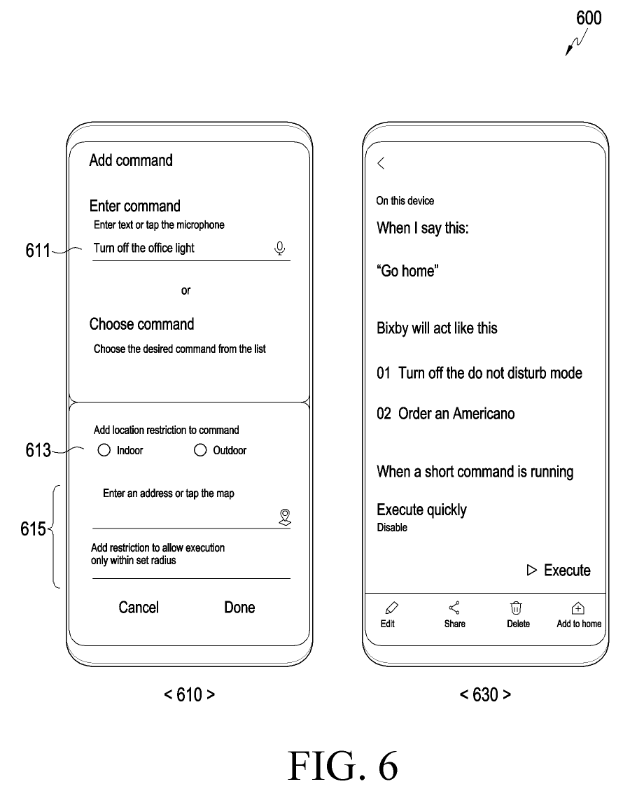

FIG. 6 is a diagram 600 illustrating an operation of setting a location-based context condition for a command by an electronic device according to an embodiment of the disclosure.

Referring to FIG. 6, when a command for controlling an external device, such as “Turn off the office light” 611, is input by a user as one of a plurality of commands to be included in a shortcut command as on a screen <610> in a process of registering the shortcut command, an electronic device (e.g., the electronic device 101 of FIG. 1, the user terminal 290 of FIG. 2, and/or the electronic device 501 of FIG. 5) may provide a menu allowing the user to set a first item 613 for inputting indoor/outdoor information and a second item 615 for inputting geofence information. The electronic device may include indoor information or outdoor information selected by the user in the first item 613 as a location-based context condition.

The electronic device may identify that the user has input address information about a location (e.g., office) for which the command "Turn off the office light" 611 is to be executed in a location information input field of the second item 615, or the user has selected the location (e.g., office) for which the command "Turn off the office lights" 611 is to be executed through a map application. When the user inputs a radius distance in a radius information input field of the second item 615, the electronic device may generate geofence information by setting a radius centered on the location information. The electronic device may include the generated geofence information as the location-based context condition.

As shown in a screen <630>, the electronic device may register a shortcut command "Go home" that includes a plurality of commands, such as "Turn off the office light" for which the location-based context condition is set and "Give me directions home" for which the location-based context condition is not set in the process of registering the shortcut command.

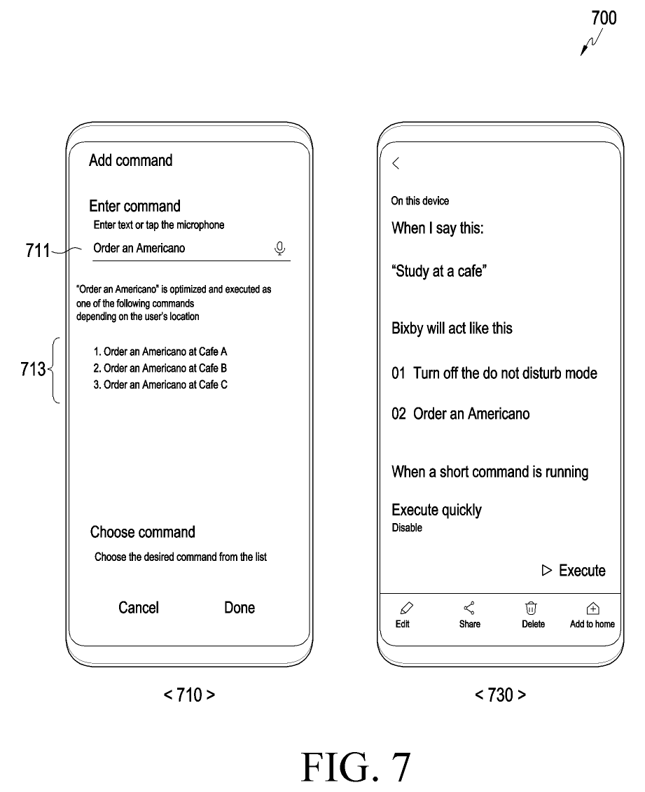

FIG. 7 is a diagram 700 illustrating an operation of setting a location-based context condition for a command by an electronic device according to an embodiment of the disclosure.

Referring to FIG. 7, in a process of registering a shortcut command, when an incomplete command requiring place information, such as “Order me an Americano” 711 is input by the user as one of a plurality of commands to be included in the shortcut command as on screen <710>, an electronic device (e.g., the electronic device 101 of FIG. 1, the user terminal 290 of FIG. 2, and/or the electronic device 501 of FIG. 5) may detect Cafe A, Cafe B, and Cafe C in which an Americano may be ordered in information about a plurality of places stored in a second DB (e.g., the second DB 533 of FIG. 5) of the memory of the electronic device, and generate a command list including Cafe A, Cafe B, and Cafe C. When the command "Order an Americano" 711 is executed, the electronic device may provide commands 713 that may be executed in one of a plurality of cafes included in the command list according to the user's location.

As shown in a screen <730>, in the process of registering a shortcut command, the electronic device may register a shortcut command "Study at a cafe" including a plurality of commands, such as "Turn on the do not disturb mode" for which a location-based context condition is not set and "Order an Americano" for which the location-based context condition is set.

According to an embodiment of the disclosure, an electronic device (101 of FIG. 1, 290 of FIG. 2, or 501 of FIG. 5) may include an input module (150 of FIG. 1, 297 of FIG. 2, or 510 of FIG. 5), memory (130 of FIG. 1 and 530 of FIG. 5) including a plurality of DBs, and a processor (120 of FIG. 1, 292 of FIG. 2, or 520 of FIG. 5).

According to an embodiment of the disclosure, the processor (120 of FIG. 1, 292 of FIG. 2, or 520 of FIG. 5) may identify a user utterance obtained through the input module as a shortcut command including a plurality of commands.

According to an embodiment of the disclosure, when identifying a command for which a location-based context condition is set among the plurality of commands while sequentially executing the plurality of commands included in the shortcut command, the processor (120 of FIG. 1, 292 of FIG. 2, or 520 of FIG. 5) may identify whether the location-based context condition is satisfied based on location information about the electronic device and location information about a target for which the command is to be executed.

According to an embodiment of the disclosure, when the location-based context condition is satisfied, the processor (120 of FIG. 1, 292 of FIG. 2, or 520 of FIG. 5) may perform a task corresponding to the command.

According to an embodiment of the disclosure, when identifying a command for which the location-based context condition is not set among the plurality of commands, the processor (120 of FIG. 1, 292 of FIG. 2, or 520 of FIG. 5) may perform the task corresponding to the command.

According to an embodiment of the disclosure, when the location-based context condition is not satisfied, the processor (120 of FIG. 1, 292 of FIG. 2, or 520 of FIG. 5) may not perform the task corresponding to the command.

According to an embodiment of the disclosure, when the location information about the electronic device and the location information about the target for which the command is to be executed satisfy at least one of geofence information or indoor/outdoor information included as the location-based context condition, the processor (120 of FIG. 1, 292 of FIG. 2, or 520 of FIG. 5) may identify that the location-based context condition is satisfied.

According to an embodiment of the disclosure, when the command for which the location-based context condition is set is a command for controlling an external device, the processor (120 of FIG. 1, 292 of FIG. 2, or 520 of FIG. 5) may identify the location information about the electronic device, and detect location information about the external device in a first DB storing information about a plurality of external devices among a plurality of DBs included in the memory.

According to an embodiment of the disclosure, when identifying that at least one of the geofence information or the indoor/outdoor information included as the location-based context condition includes the location information about the electronic device and the location information about the external device, the processor (120 of FIG. 1, 292 of FIG. 2, or 520 of FIG. 5) may identify that the location-based context condition is satisfied and perform a task for controlling the external device.

According to an embodiment of the disclosure, when identifying that the location-based context condition is not satisfied, the processor (120 of FIG. 1, 292 of FIG. 2, or 520 of FIG. 5) may not perform the task for controlling the external device.

According to an embodiment of the disclosure, when the command for which the location-based context condition is set is an incomplete command requiring place information, the processor (120 of FIG. 1, 292 of FIG. 2, or 520 of FIG. 5) may detect a command list including information about a plurality of places generated for the incomplete command, and identify the location information about the electronic device.

According to an embodiment of the disclosure, when detecting information about a place existing within a specific range in the information about the plurality of places included in the command list based on the location information about the electronic device, the processor (120 of FIG. 1, 292 of FIG. 2, or 520 of FIG. 5) may identify that the location-based context condition is satisfied, and perform a task corresponding to the incomplete command based on the detected information about the place.

According to an embodiment of the disclosure, when detecting information about a plurality of places within the specific range in the information about the plurality of places included in the command list, using a second DB storing information about a plurality of places among the plurality of DBs of the memory, the processor (120 of FIG. 1, 292 of FIG. 2, or 520 of FIG. 5) may detect information about a place existing at a shortest distance from the electronic device in the information about the plurality of places.

According to an embodiment of the disclosure, when detecting information about a plurality of places existing at the shortest distance from the location information about the electronic device in the information about the plurality of places included in the command list, the processor (120 of FIG. 1, 292 of FIG. 2, or 520 of FIG. 5) may provide a UI allowing a user to select from the information about the plurality of places.

According to an embodiment of the disclosure, when information about a matching location does not exist in the information about the plurality of places included in the command list based on the location information about the electronic device, using the second DB storing the information about the plurality of places among the plurality of DBs of the memory, the processor (120 of FIG. 1, 292 of FIG. 2, or 520 of FIG. 5) may identify that the location-based context condition is not satisfied, and may not perform the task corresponding to the command.

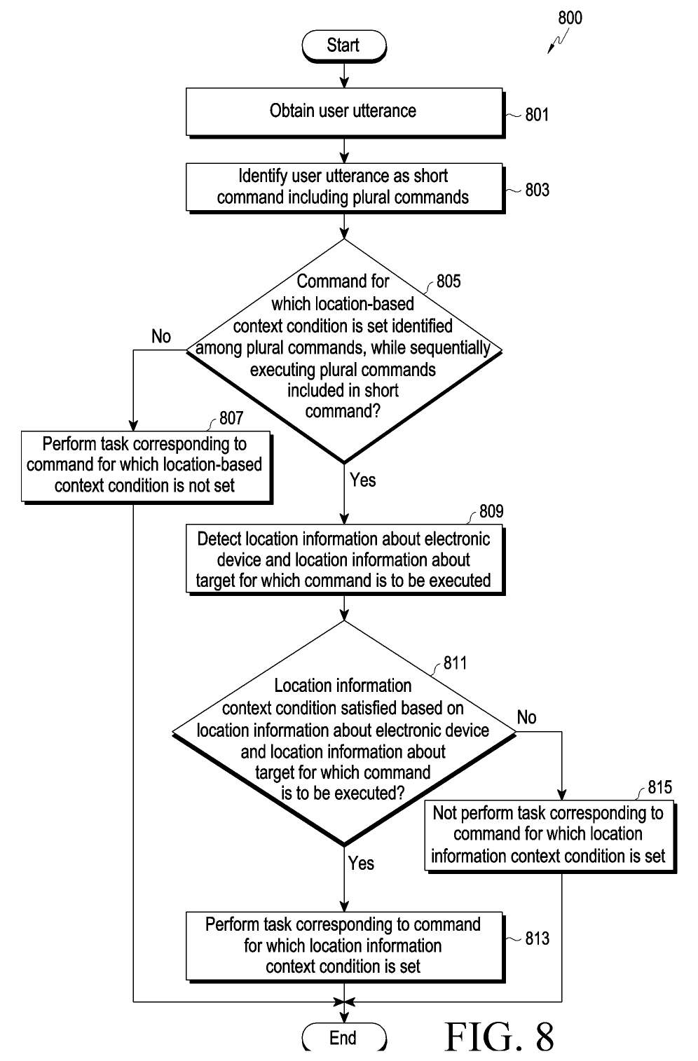

FIG. 8 is a flowchart 800 illustrating an operation of processing a user utterance using a location-based context in an electronic device according to an embodiment of the disclosure.

Referring to FIG. 8, the operation of processing a user utterance may include operations 801 to 815. In the following embodiment of the disclosure, the operations may be performed sequentially, but not necessarily. For example, the order of each operation may be changed, at least two operations may be performed in parallel, or another operation may be added.

According to an embodiment of the disclosure, operations 801 to 815 may be understood to be performed by a processor (e.g., the processor 120 of FIG. 1, the processor 292 of FIG. 2, and/or the processor 520 of FIG. 5) of an electronic device (e.g., the electronic device 101 of FIG. 1, the user terminal 290 of FIG. 2, and/or the electronic device 501 of FIG. 5).

Although a plurality of commands included in a shortcut command are described as sequentially executed in FIG. 8, the plurality of commands included in the shortcut command may be executed in parallel.

In operation 801, the electronic device (e.g., the electronic device 101 of FIG. 1, the user terminal 290 of FIG. 2, and/or the electronic device 501 of FIG. 5) may obtain a user utterance.

According to an embodiment of the disclosure, the electronic device may obtain the user utterance through an input module (e.g., the input module 510 of FIG. 5).

In operation 803, the electronic device (e.g., the electronic device 101 of FIG. 1, the user terminal 290 of FIG. 2, and/or the electronic device 501 of FIG. 5) may identify the user utterance as a shortcut command including a plurality of commands.

According to an embodiment of the disclosure, the electronic device may identify the user utterance as the shortcut command including the plurality of commands through an utterance processing module (e.g., the utterance processing module 550 of FIG. 5).

In operation 805, the electronic device (e.g., the electronic device 101 of FIG. 1, the user terminal 290 of FIG. 2, and/or the electronic device 501 of FIG. 5) may identify whether there is a command for which a location-based context condition is set among the plurality of commands, while sequentially executing the plurality of commands included in the shortcut command.

According to an embodiment of the disclosure, the location-based context condition may include at least one of geofence information or indoor/outdoor information.

According to an embodiment of the disclosure, the location-based context condition may be set by a user through a UI provided by the electronic device, or may be set by a developer or manager of a voice service, an IoT developer or manager, or a POI developer or manager.

In operation 805, when the electronic device identifies a command for which the location-based context condition is not set among the plurality of commands (operation 805-No), in operation 807, the electronic device may perform a task corresponding to the command for which the location-based context condition is not set.

In operation 805, when the electronic device identifies a command for which the location-based context condition is set among the plurality of commands (operation 805-Yes), in operation 809, the electronic device may detect location information about the electronic device and location information about a target for which the command is to be executed.

According to an embodiment of the disclosure, when the target for the command is to be executed is an external device, the electronic device may detect location information about the external device in a first DB (e.g., the first DB 531 of FIG. 5) of the memory of the electronic device.

According to an embodiment of the disclosure, when the target for which the command is to be executed is a place, the electronic device may identify a command list including information about a plurality of places generated based on a second DB (e.g., the second DB 533 of FIG. 5) in the memory of the electronic device.

In operation 811, the electronic device (e.g., the electronic device 101 of FIG. 1, the user terminal 290 of FIG. 2, and/or the electronic device 501 of FIG. 5) may identify whether the location-based context condition is satisfied based on the location information about the electronic device and the location information about the target for which the command is to be executed.

In operation 811, when the electronic device identifies that the location-based context condition is satisfied (operation 811-Yes), in operation 813 the electronic device may perform a task corresponding to the command for which the location-based context condition is set.

According to an embodiment of the disclosure, in the case where the location information about the target for which the command is to be executed is an external device, when the location of the electronic device and the location of the external device are included in the geofence information and/or indoor/outdoor information set as the location-based context condition based on the location information about the electronic device and the location information about the external device, the electronic device may identify that the location-based context condition is satisfied.

According to an embodiment of the disclosure, in the case where the location information about the target for which the command is to be executed is a place, when there is information about a place existing within a specific range based on the location information about the electronic device in the information about the places included in the command list generated based on the second DB (e.g., the second DB 533 of FIG. 5) in the memory of the electronic device, the electronic device may identify that the location-based context condition is satisfied.

In operation 811, when the electronic device does not identify that the location-based context condition is satisfied (operation 811-No), in operation 815 the electronic device may not perform the task corresponding to the command for which the location-based context condition is set.

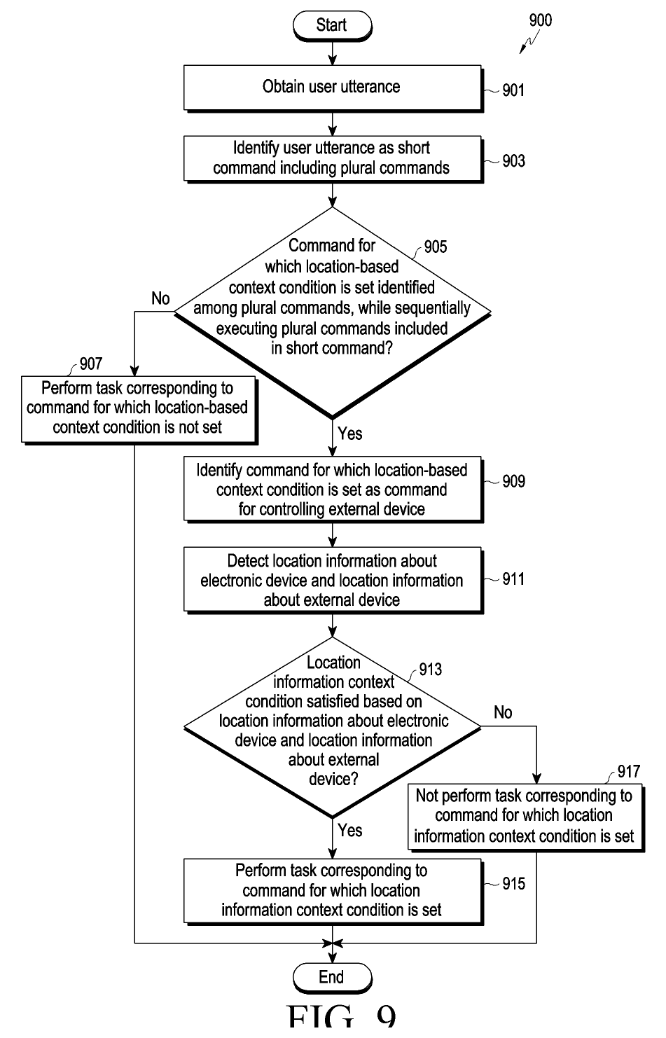

FIG. 9 is a flowchart 900 illustrating an operation of processing a user utterance using a location-based context in an electronic device according to an embodiment of the disclosure.

Referring to FIG. 9, the operation of processing a user utterance may include operations 901 to 917. In the following embodiment of the disclosure, the operations may be performed sequentially, but not necessarily. For example, the order of each operation may be changed, at least two operations may be performed in parallel, or another operation may be added.

According to an embodiment of the disclosure, operations 901 to 917 may be understood to be performed by a processor (e.g., the processor 120 of FIG. 1, the processor 292 of FIG. 2, and/or the processor 520 of FIG. 5) of an electronic device (e.g., the electronic device 101 of FIG. 1, the user terminal 290 of FIG. 2, and/or the electronic device 501 of FIG. 5).

Although a plurality of commands included in a shortcut command are described as sequentially executed in FIG. 9, the plurality of commands included in the shortcut command may be executed in parallel.

In operation 901, the electronic device (e.g., the electronic device 101 of FIG. 1, the user terminal 290 of FIG. 2, and/or the electronic device 501 of FIG. 5) may obtain a user utterance.

According to an embodiment of the disclosure, the electronic device may obtain the user utterance through an input module (e.g., the input module 510 of FIG. 5).

In operation 903, the electronic device (e.g., the electronic device 101 of FIG. 1, the user terminal 290 of FIG. 2, and/or the electronic device 501 of FIG. 5) may identify the user utterance as a shortcut command including a plurality of commands.

According to an embodiment of the disclosure, the electronic device may identify the user utterance as the shortcut command including the plurality of commands through an utterance processing module (e.g., the utterance processing module 550 of FIG. 5).

In operation 905, the electronic device (e.g., the electronic device 101 of FIG. 1, the user terminal 290 of FIG. 2, and/or the electronic device 501 of FIG. 5) may identify whether there is a command for which a location-based context condition is set among the plurality of commands, while sequentially executing the plurality of commands included in the shortcut command.

According to an embodiment of the disclosure, the location-based context condition may include at least one of geofence information or indoor/outdoor information.

According to an embodiment of the disclosure, the location-based context condition may be set by a user through a UI provided by the electronic device, or may be set by a developer or manager of a voice service, an IoT developer or manager, or a POI developer or manager.

In operation 905, when the electronic device identifies a command for which the location-based context condition is not set among the plurality of commands (operation 905-No), in operation 907, the electronic device may perform a task corresponding to the command for which the location-based context condition is not set.

in operation 905, when the electronic device identifies a command for which the location-based context condition is set among the plurality of commands (operation 905-Yes), in operation 909, the electronic device may identify the command for which the location-based context condition is set, as a command for controlling an external device.

In operation 911, the electronic device (e.g., the electronic device 101 of FIG. 1, the user terminal 290 of FIG. 2, and/or the electronic device 501 of FIG. 5) may detect location information about the electronic device and location information about the external device.

According to an embodiment of the disclosure, the electronic device may identify current location information (e.g., latitude and longitude information) about the electronic device, and detect the location information about the external device in a first DB (e.g., the first DB 531 of FIG. 5) storing information about a plurality of external devices among a plurality of DBs included in memory (e.g., the memory 530 of FIG. 5).

According to an embodiment of the disclosure, the electronic device may detect, for example, latitude and longitude information and/or indoor/outdoor information indicating whether the external device is indoors or outdoors, as location information about the external device included in the command in the information about the plurality of external devices stored in the first DB.

In operation 913, the electronic device (e.g., the electronic device 101 of FIG. 1, the user terminal 290 of FIG. 2, and/or the electronic device 501 of FIG. 5) may identify whether the location-based context condition is satisfied based on the location information about the electronic device and the location information about the external device.

In operation 913, when the electronic device identifies that the location-based context condition is satisfied (operation 913-Yes), in operation 915, the electronic device may perform a task corresponding to the command for which the location-based context condition is set.

According to an embodiment of the disclosure, the electronic device may identify the geofence information as the location-based context condition set for the command for controlling the external device. When identifying that the electronic device and the external device exist within a specific area specified by the geofence based on the location information (e.g., latitude and longitude information) about the electronic device and the location information (e.g., latitude and longitude information) about the external device, the electronic device may determine that the location-based context condition is satisfied and perform a task for controlling the external device.

According to an embodiment of the disclosure, the electronic device may identify the geofence information and the indoor/outdoor information as the location-based context condition set for the command for controlling the external device. When the electronic device and the external device exist within the specific area specified by the geofence based on the location information (e.g., latitude and longitude information) about the electronic device and the location information (e.g., latitude and longitude information) about the external device and satisfy the indoor/outdoor information, the electronic device may determine that the location-based context condition is satisfied and perform the task for controlling the external device.

In operation 913, when the electronic device does not identify that the location-based context condition is satisfied (operation 913-No), in operation 917, the electronic device may not perform the task corresponding to the command for which the location-based context condition is set.

According to an embodiment of the disclosure, the electronic device may identify the geofence information as the location-based context condition set for the command for controlling the external device. When identifying that the electronic device and the external device do not exist within the specific area specified by the geofence based on the location information (e.g., latitude and longitude information) about the electronic device and the location information (e.g., latitude and longitude information) about the external device, the electronic device may determine that the location-based context condition is not satisfied and may not perform the task for controlling the external device.

According to an embodiment of the disclosure, the electronic device may identify the geofence information and the indoor/outdoor information as the location-based context condition set for the command for controlling the external device. When the electronic device and the external device do not exist within the specific area specified by the geofence based on the location information (e.g., latitude and longitude information) about the electronic device and the location information (e.g., latitude and longitude information) about the external device or does not satisfy the indoor/outdoor information, the electronic device may determine that the location-based context condition is not satisfied and may not perform the task for controlling the external device.

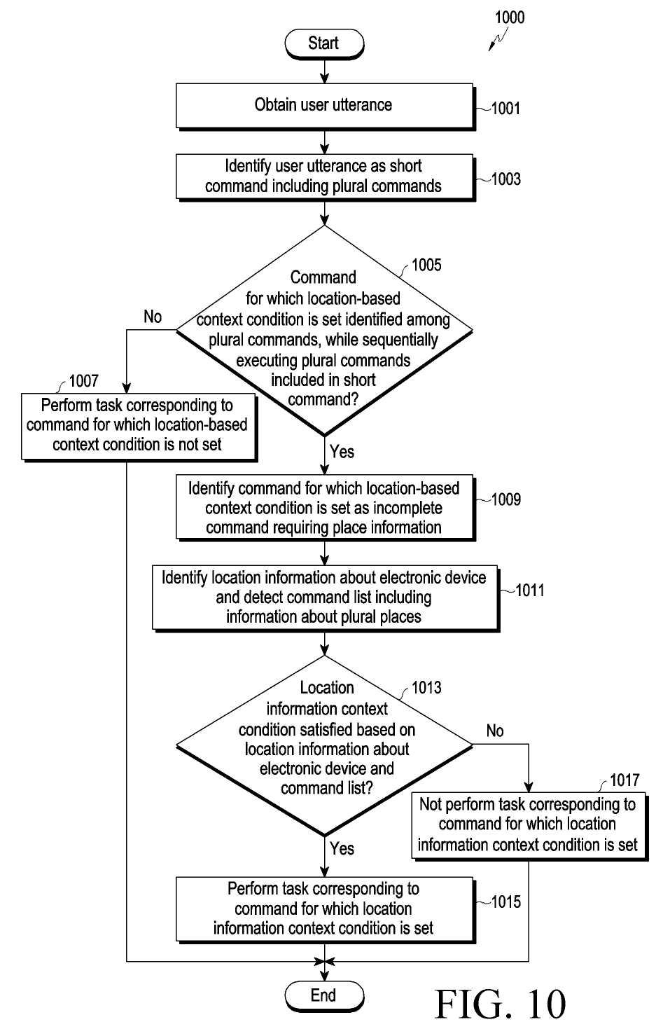

FIG. 10 is a flowchart 1000 illustrating an operation of processing a user utterance using a location-based context in an electronic device according to an embodiment of the disclosure.

Referring to FIG. 10, he operation of processing a user utterance may include operations 1001 to 1017. In the following embodiment of the disclosure, the operations may be performed sequentially, but not necessarily. For example, the order of each operation may be changed, at least two operations may be performed in parallel, or another operation may be added.

According to an embodiment of the disclosure, operations 1001 to 1017 may be understood to be performed by a processor (e.g., the processor 120 of FIG. 1, the processor 292 of FIG. 2, and/or the processor 520 of FIG. 5) of an electronic device (e.g., the electronic device 101 of FIG. 1, the user terminal 290 of FIG. 2, and/or the electronic device 501 of FIG. 5).

Although a plurality of commands included in a shortcut command are described as sequentially executed in FIG. 10, the plurality of commands included in the shortcut command may be executed in parallel.

In operation 1001, the electronic device (e.g., the electronic device 101 of FIG. 1, the user terminal 290 of FIG. 2, and/or the electronic device 501 of FIG. 5) may obtain a user utterance.

According to an embodiment of the disclosure, the electronic device may obtain the user utterance through an input module (e.g., the input module 510 of FIG. 5).

In operation 1003, the electronic device (e.g., the electronic device 101 of FIG. 1, the user terminal 290 of FIG. 2, and/or the electronic device 501 of FIG. 5) may identify the user utterance as a shortcut command including a plurality of commands.

According to an embodiment of the disclosure, the electronic device may identify the user utterance as the shortcut command including the plurality of commands through an utterance processing module (e.g., the utterance processing module 550 of FIG. 5).

In operation 1005, the electronic device (e.g., the electronic device 101 of FIG. 1, the user terminal 290 of FIG. 2, and/or the electronic device 501 of FIG. 5) may identify whether there is a command for which a location-based context condition is set among the plurality of commands, while sequentially executing the plurality of commands included in the shortcut command.

According to an embodiment of the disclosure, the location-based context condition may include at least one of geofence information or indoor/outdoor information.

According to an embodiment of the disclosure, the location-based context condition may be set by a user through a UI provided by the electronic device, or may be set by a developer or manager of a voice service, an IoT developer or manager, or a POI developer or manager.

In operation 1005, when the electronic device identifies a command for which the location-based context condition is not set among the plurality of commands (operation 1005-No), In operation 1007, the electronic device may perform a task corresponding to the command for which the location-based context condition is not set.

In operation 1005, when the electronic device identifies a command for which the location-based context condition is set among the plurality of commands (operation 1005-Yes), in operation 1009, the electronic device may identify the command for which the location-based context condition is set, as a command requiring place information.

In operation 1011, the electronic device (e.g., the electronic device 101 of FIG. 1, the user terminal 290 of FIG. 2, and/or the electronic device 501 of FIG. 5) may identify location information about the electronic device and detect a command list including information about a plurality of places.

According to an embodiment of the disclosure, the electronic device may identify current location information (e.g., latitude and longitude information) about the electronic device, and detect a command list including information about a plurality of places generated for the incomplete command.

In operation 1013, the electronic device (e.g., the electronic device 101 of FIG. 1, the user terminal 290 of FIG. 2, and/or the electronic device 501 of FIG. 5) may identify whether a location-based context condition is satisfied based on the location information about the electronic device and the command list.

In operation 1013, when the electronic device identifies that the location-based context condition is satisfied (operation 1013-Yes), in operation 1015, the electronic device may perform a task corresponding to the command for which the location-based context condition is set.

According to an embodiment of the disclosure, when the electronic device detects information about a place existing within a specific range based on the current location information about the electronic device among the plurality of places included in the command list, the electronic device may identify that the location-based context condition is satisfied and perform a task corresponding to the incomplete command based on the detected information about the place.

According to an embodiment of the disclosure, when the electronic device detects information about a plurality of places within the specific range based on the location information about the electronic device in the information about the plurality of places included in the command list, using a second DB (e.g., the second DB 533 of FIG. 5) storing information about a plurality of places among a plurality of DBs in the memory (e.g., the memory 530 of FIG. 5) of the electronic device, the electronic device may detect information about a place at the shortest distance from the electronic device in the information about the plurality of places.

According to an embodiment of the disclosure, when the electronic device detects information about a plurality of places at the shortest distance from the electronic device in the information about the plurality of places included in the command list, using the second DB, the electronic device may provide a UI allowing the user to select from among the plurality of places.

In operation 1013, when the electronic device does not identify that the location-based context condition is satisfied (operation 1013-No), in operation 1017, the electronic device may not perform the task corresponding to the command for which the location-based context condition is set.

According to an embodiment of the disclosure, when there is no information about a place matching the location information about the electronic device in the information about the plurality of places included in the command list, the electronic device may identify that the location-based context condition is not satisfied, and may not perform the task corresponding to incomplete command requiring place information.

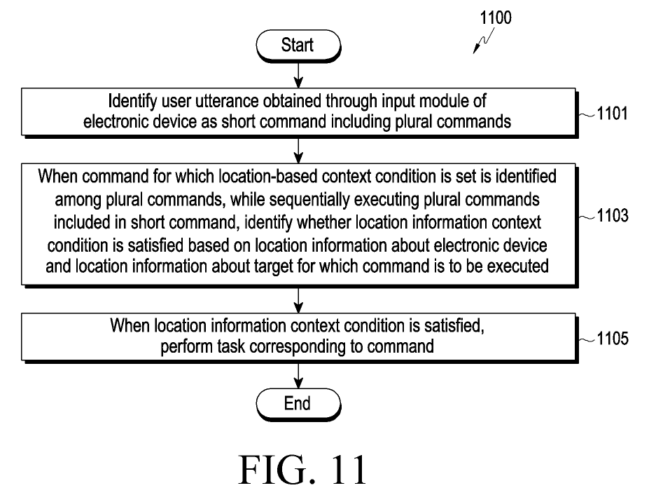

FIG. 11 is a flowchart 1100 illustrating an operation of processing a user utterance using a location-based context in an electronic device according to an embodiment of the disclosure.

Referring to FIG. 11, the operation of processing a user utterance may include operations 1101 to 1105. In the following embodiment of the disclosure, the operations may be performed sequentially, but not necessarily. For example, the order of each operation may be changed, at least two operations may be performed in parallel, or another operation may be added.

According to an embodiment of the disclosure, operations 1101 to 1105 may be understood to be performed by a processor (e.g., the processor 120 of FIG. 1, the processor 292 of FIG. 2, and/or the processor 520 of FIG. 5) of an electronic device (e.g., the electronic device 101 of FIG. 1, the user terminal 290 of FIG. 2, and/or the electronic device 501 of FIG. 5).

Although a plurality of commands included in a shortcut command are described as sequentially executed in FIG. 11, the plurality of commands included in the shortcut command may be executed in parallel.

In operation 1101, the electronic device (e.g., the electronic device 101 of FIG. 1, the user terminal 290 of FIG. 2, and/or the electronic device 501 of FIG. 5) may identify a user utterance obtained through an input module (e.g., the input module 510 of FIG. 5) of the electronic device as a shortcut command including a plurality of commands.

In operation 1103, when the electronic device (e.g., the electronic device 101 of FIG. 1, the user terminal 290 of FIG. 2, and/or the electronic device 501 of FIG. 5) identifies a command for which a location-based context condition is set among the plurality of commands, while sequentially executing the plurality of commands included in the shortcut command, the electronic device may identify whether the location-based context condition is satisfied based on location information about the electronic device and location information about a target for which the command is to be executed.

According to an embodiment of the disclosure, when the electronic device identifies the command for which the location-based context condition is set among the plurality of commands, the electronic device may detect the location information about the electronic device and the location information about a target for which the command is to be executed.

According to an embodiment of the disclosure, when the target for which the command is to be executed is an external device, the electronic device may detect location information about the external device from a first DB (e.g., the first DB 531 of FIG. 5) in memory of the electronic device.

According to an embodiment of the disclosure, when the target for which the command is to be executed is a place, the electronic device may identify a command list including information about a plurality of places generated based on a second DB (e.g., the second DB 533 of FIG. 5) in the memory of the electronic device.

According to an embodiment of the disclosure, the location-based context condition may include at least one of geofence information or indoor/outdoor information.

According to an embodiment of the disclosure, the location-based context condition may be set by a user through a UI provided by the electronic device, or may be set by a developer or manager of a voice service, an IoT developer or manager, or a PoI developer or manager.

In operation 1105, when the location-based context condition is satisfied, the electronic device (e.g., the electronic device 101 of FIG. 1, the user terminal 290 of FIG. 2, and/or the electronic device 501 of FIG. 5) may perform a task corresponding to the command.

According to an embodiment of the disclosure, a method of processing a user utterance using a location-based context in an electronic device may include identifying a user utterance obtained through an input module of the electronic device as a shortcut command including a plurality of commands.

According to an embodiment of the disclosure, the method may include, when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed.

According to an embodiment of the disclosure, the method may include performing a task corresponding to the command, when the location-based context condition is satisfied.

According to an embodiment of the disclosure, the method may further include, when identifying a command for which the location-based context condition is not set, performing a task corresponding to the command.

According to an embodiment of the disclosure, the method may further include, when identifying that the location-based context condition is not satisfied, performing a task corresponding to the command.

According to an embodiment of the disclosure, the method may further include, identifying that the location-based context condition is satisfied, when the location information about the electronic device and the location information about the target for which the command is to be executed satisfy at least one of geofence information or indoor/outdoor information included as the location-based context condition.

According to an embodiment of the disclosure, the method may include, when the command for which the location-based context condition is set is a command for controlling an external device, identifying the location information about the electronic device, and detecting location information about the external device in a first DB storing information about a plurality of external devices among a plurality of DBs included in memory.

According to an embodiment of the disclosure, the method may further include, when identifying that the location information about the electronic device and the location information about the external device are included in at least one of the geofence information or the indoor/outdoor information included as the location-based context condition, identifying that the location-based context condition is satisfied and performing a task for controlling the external device.

According to an embodiment of the disclosure, the method may further include, when identifying that the location-based context condition is not satisfied, not performing the task for controlling the external device.

According to an embodiment of the disclosure, the method may include, when the command for which the location-based context condition is set is an incomplete command requiring place information, detecting a command list including information about a plurality of places generated for the incomplete command, and identifying the location information about the electronic device.

According to an embodiment of the disclosure, the method may include, when detecting information about a place existing within a specific range in the information about the plurality of places included in the command list based on the location information about the electronic device, identifying that the location-based context condition is satisfied.

According to an embodiment of the disclosure, the method may further include performing a task corresponding to the incomplete command based on the detected information about the place.

According to an embodiment of the disclosure, the method may further include, when detecting information about a plurality of places within the specific range in the information about the plurality of places included in the command list, using a second DB storing information about a plurality of places among the plurality of DBs of the memory, detecting information about a place existing at a shortest distance from the electronic device in the information about the plurality of places.

According to an embodiment of the disclosure, the method may further include, when detecting information about a plurality of places existing at the shortest distance from the location information about the electronic device in the information about the plurality of places included in the command list, providing a UI allowing a user to select from the information about the plurality of places.

According to an embodiment of the disclosure, the method may further include, when information about a matching location does not exist in the information about the plurality of places included in the command list based on the location information about the electronic device, using the second DB storing the information about the plurality of places among the plurality of DBs of the memory, identifying that the location-based context condition is not satisfied, and not performing the task corresponding to the command.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. As used herein, each of such phrases as "A or B”, "at least one of A and B”, "at least one of A or B”, "A, B, or C”, "at least one of A, B, and C”, and "at least one of A, B, or C”, may include any one of, or all possible combinations of the items enumerated together in a corresponding one of the phrases. As used herein, such terms as "1^{st}" and "2^{nd}”, or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with”, "coupled to”, "connected with”, or "connected to" another element (e.g., a second element), it means that the element may be coupled with the other element directly (e.g., wiredly), wirelessly, or via a third element.

As used in connection with an embodiment of the disclosure, the term "module" may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment of the disclosure, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 520) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

According to an embodiment of the disclosure, in a non-volatile storage medium storing instructions that, when executed by an electronic device, enable the electronic device to perform at least one operation, the at least one operation may include identifying a user utterance obtained through an input module of the electronic device as a shortcut command including a plurality of commands, when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed, and performing a task corresponding to the command, when the location-based context condition is satisfied.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
an input module;
memory storing one or more computer programs; and
at least one processor communicatively coupled to the input module and the memory,
wherein the one or more computer programs include computer-executable instructions that, when executed by the at least one processor individually or collectively, cause the electronic device to:
identify a user utterance obtained through the input module as a shortcut command including a plurality of commands,
when identifying a command for which a location-based context condition is set among the plurality of commands while sequentially executing the plurality of commands included in the shortcut command, identify whether the location-based context condition is satisfied based on location information about the electronic device and location information about a target for which the command is to be executed, and
perform a task corresponding to the command, when the location-based context condition is satisfied.

2. The electronic device of claim 1, wherein the one or more computer programs further include computer-executable instructions that, when executed by the at least one processor individually or collectively, cause the electronic device to:
when the location information about the electronic device and the location information about the target for which the command is to be executed satisfy at least one of geofence information or indoor/outdoor information included as the location-based context condition, identify that the location-based context condition is satisfied.

3. The electronic device of claim 1, wherein the one or more computer programs further include computer-executable instructions that, when executed by the at least one processor individually or collectively, cause the electronic device to:
when the command for which the location-based context condition is set is a command for controlling an external device, identify the location information about the electronic device, and detect location information about the external device in a first database (DB) storing information about a plurality of external devices among a plurality of DBs included in the memory; and
when identifying that the location information about the electronic device and the location information about the external device are included in at least one of geofence information or the indoor/outdoor information included as the location-based context condition, identify that the location-based context condition is satisfied and perform a task for controlling the external device.

4. The electronic device of claim 3, wherein the one or more computer programs further include computer-executable instructions that, when executed by the at least one processor individually or collectively, cause the electronic device to:
not perform the task for controlling the external device, when identifying that the location-based context condition is not satisfied.

5. The electronic device of claim 1, wherein the one or more computer programs further include computer-executable instructions that, when executed by the at least one processor individually or collectively, cause the electronic device to:
when the command for which the location-based context condition is set is an incomplete command requiring place information, detect a command list including information about a plurality of places generated for the incomplete command, and identify the location information about the electronic device;
when detecting information about a place existing within a specific range in the information about the plurality of places included in the command list based on the location information about the electronic device, identify that the location-based context condition is satisfied; and
perform a task corresponding to the incomplete command based on the detected information about the place.

6. The electronic device of any one of claim 5,
wherein the one or more computer programs further include computer-executable instructions that, when executed by the at least one processor individually or collectively, cause the electronic device to:
when detecting information about a plurality of places within the specific range in the information about the plurality of places included in the command list, using a second DB storing information about a plurality of places among a plurality of DBs of the memory, detect information about a place existing at a shortest distance from the electronic device in the information about the plurality of places.

7. The electronic device of claim 5, wherein the one or more computer programs further include computer-executable instructions that, when executed by the at least one processor individually or collectively, cause the electronic device to:
when detecting information about a plurality of places existing at the shortest distance from the location information about the electronic device in the information about the plurality of places included in the command list, provide a user interface (UI) allowing a user to select from the information about the plurality of places.

8. The electronic device of claim 5, wherein the one or more computer programs further include computer-executable instructions that, when executed by the at least one processor individually or collectively, cause the electronic device to:
when information about a matching location does not exist in the information about the plurality of places included in the command list based on the location information about the electronic device, using a second DB storing the information about the plurality of places among a plurality of DBs of the memory, identify that the location-based context condition is not satisfied, and not perform the task corresponding to the command.

9. A method of processing a user utterance using a location-based context in an electronic device, the method comprising:
identifying a user utterance obtained through an input module of the electronic device as a shortcut command including a plurality of commands;
when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed; and
performing a task corresponding to the command, when the location-based context condition is satisfied.

10. The method of claim 9, further comprising:
identifying that the location-based context condition is satisfied, when the location information about the electronic device and the location information about the target for which the command is to be executed satisfy at least one of geofence information or indoor/outdoor information included as the location-based context condition.

11. The method of claim 9, further comprising:
when the command for which the location-based context condition is set is a command for controlling an external device, identifying the location information about the electronic device, and detecting location information about the external device in a first database (DB) storing information about a plurality of external devices among a plurality of DBs included in memory; and
when identifying that the location information about the electronic device and the location information about the external device are included in at least one of geofence information or the indoor/outdoor information included as the location-based context condition, identifying that the location-based context condition is satisfied and performing a task for controlling the external device.

12. The method of claim 9, further comprising:
when the command for which the location-based context condition is set is an incomplete command requiring place information, detecting a command list including information about a plurality of places generated for the incomplete command, and identifying the location information about the electronic device;
when detecting information about a place existing within a specific range in the information about the plurality of places included in the command list based on the location information about the electronic device, identifying that the location-based context condition is satisfied; and
performing a task corresponding to the incomplete command based on the detected information about the place.

13. The method of claim 12, further comprising:
when detecting information about a plurality of places within the specific range in the information about the plurality of places included in the command list, using a second DB storing information about a plurality of places among a plurality of DBs of memory, detecting information about a place existing at a shortest distance from the electronic device in the information about the plurality of places.

14. The method of claim 12, further comprising:
when detecting information about a plurality of places existing at the shortest distance from the location information about the electronic device in the information about the plurality of places included in the command list, providing a UI allowing a user to select from the information about the plurality of places.

15. The method of claim 12, further comprising:
when information about a matching location does not exist in the information about the plurality of places included in the command list based on the location information about the electronic device, using a second DB storing the information about the plurality of places among a plurality of DBs of memory, identifying that the location-based context condition is not satisfied, and not performing the task corresponding to the command.

16. The method of claim 11, further comprising:
not performing the task for controlling the external device, when identifying that the location-based context condition is not satisfied.

17. One or more non-transitory computer-readable storage media storing one or more computer programs including computer-executable instructions that, when executed by one or more processors of an electronic device individually or collectively, cause the electronic device to perform operations, the operations comprising:
identifying a user utterance obtained through an input module of the electronic device as a shortcut command including a plurality of commands;
when identifying a command for which a location-based context condition is set among the plurality of commands while sequentially executing the plurality of commands included in the shortcut command, identifying whether the location-based context condition is satisfied based on location information about the electronic device and location information about a target for which the command is to be executed; and
performing a task corresponding to the command, when the location-based context condition is satisfied.

18. The one or more non-transitory computer-readable storage media of claim 17, the operations further comprising:
identifying that the location-based context condition is satisfied, when the location information about the electronic device and the location information about the target for which the command is to be executed satisfy at least one of geofence information or indoor/outdoor information included as the location-based context condition.

19. The one or more non-transitory computer-readable storage media of claim 18, further comprising:
when the command for which the location-based context condition is set is a command for controlling an external device, identifying the location information about the electronic device, and detecting location information about the external device in a first database (DB) storing information about a plurality of external devices among a plurality of DBs included in memory; and
when identifying that the location information about the electronic device and the location information about the external device are included in at least one of the geofence information or the indoor/outdoor information included as the location-based context condition, identifying that the location-based context condition is satisfied and performing a task for controlling the external device.

20. The one or more non-transitory computer-readable storage media of claim 18, further comprising:
when the command for which the location-based context condition is set is an incomplete command requiring place information, detecting a command list including information about a plurality of places generated for the incomplete command, and identifying the location information about the electronic device;
when detecting information about a place existing within a specific range in the information about the plurality of places included in the command list based on the location information about the electronic device, identifying that the location-based context condition is satisfied; and
performing a task corresponding to the incomplete command based on the detected information about the place.
